(19) United States
(12) Patent Application Publication
(10) Pub. No.: US 2002/0038930 A1
(43) Pub. Date: Apr. 4, 2002

(54) Welding clamp having a removal tab

(76) Inventor: Raymond Leon JR., Indio, CA (US)

Correspondence Address: Timothy T. Tyson, Freilich, Hornbaker & Rosen, Suite 1220, 10960 Wilshire Blvd., Los Angeles, CA, 90024, US

(21) Appl. No.: 09/969,930

(22) Filed: Oct. 3, 2001

Related U.S. Application Data
(60) Provisional application No. 60/237,135, filed on Oct. 3, 2000.

(51) Int. Cl. B25B 11/00

(52) U.S. Cl. 269/8

(57) ABSTRACT

A welding clamp (20) includes a magnetic ground clamp (22) to which a removal tab (28) is attached. Welding clamp (20) may be removed from a magnetic object (500) by using removal tab (28) to lift clamp (20) from object (500). A second embodiment (40) has two welding clamps (20) welded to a hinge (42) between them. A bolt (48) in the hinge (42) secures the hinge so that the two clamps (20) remain in a fixed position in relation to each other.

### CROSS REFERENCE TO RELATED APPLICATION

This application claims the filing benefit under 35 U.S.C. §119(e) of U.S. Provisional Application No. 60/237,135, filed Oct. 3, 2000, which is included herein by reference.

### TECHNICAL FIELD

The present invention pertains generally to welding, and in particular to a welding clamp having a magnet for attaching the clamp to a magnetic object to provide a ground during arc welding. The welding clamp has a removal tab which is useful in detaching the clamp from the magnetic object.

### BACKGROUND ART

When arc welding, it is necessary to attach a ground to the object being welded while the other pole of the electric circuit is the welding rod. When the electricity passes through the welding rod to the object, it melts the tip of the welding rod thereby depositing molten metal on the object.

Usually a spring clamp is used to connect the ground cable from the welding apparatus to the object. Nuts on the top of the clamps are used to attach the lug of the ground cable to the clamps. In another common embodiment, a spring loaded terminal is attached to a flat magnetic clamp. The spring loaded terminal has a bolt that passes through the middle of the magnet and abuts the object to be welded. In this fashion, the electric current does not pass through the magnet, but rather is shunted directly through the bolt.

U.S. Pat. No. 2,884,698 shows a magnetic holding device having a hinge in the middle and round magnets on either side but does not include a provision for attaching a ground cable. The holding device may be rotated from a flat position with the round magnets in the same plane to 90° on either side. Thus, the holding device can be positioned on the outside of two steel pieces to form a corner when the faces of the magnets are rotated toward each other. Or the holding device can be positioned on the inside of two steel pieces to form a comer when the faces of the magnets are rotated away from each other.

### DISCLOSURE OF INVENTION

The present invention is directed to a magnetic welding clamp which can be easily and quickly removed from a magnetic object after the completion of a welding operation. Prior art welding clamps are difficult to remove in that the magnetic force is strong and the clamps have little structure by which a user can grip the clamp to effect removal. The present invention solves this problem by providing a removal tab which is simply lifted to remove the clamp from the magnetic object. The removal tab provides the necessary leverage to break the magnetic attraction.

In accordance with a preferred embodiment, the welding clamp includes a magnetic ground clamp and a removal tab connected to the ground clamp.

In accordance with an important feature, the welding clamp further includes the magnetic ground clamp being circular.

In accordance with another important feature, the welding clamp further includes the magnetic ground clamp having a threaded post and at least one nut, the removal tab having a hole to receive the threaded post, and the nut used to secure the removal tab to the magnetic ground clamp.

In accordance with a preferred embodiment, a method is provided for removing a welding clamp from a magnetic object, including providing a magnetic object and a welding clamp having a removal tab. The welding clamp is attached to the magnetic object and the removal tab is used to remove the welding clamp from the magnetic object.

In accordance with a second preferred embodiment, the welding clamp includes two magnetic ground clamps coupled together by a hinge in the middle. A removal tab is connected to at least one of the two ground clamps.

Other features and advantages of the present invention will become apparent from the following detailed description, taken in conjunction with the accompanying drawings, which illustrate, by way of example, the principles of the invention.

### BRIEF DESCRIPTION OF DRAWINGS

FIG. 1 is a side perspective view of a welding clamp in accordance with the present invention;

FIG. 2 is a bottom perspective view of the welding clamp;

FIG. 3 is a side perspective view of the welding clamp attached to a flat magnetic object;

FIG. 4 is a side view of the welding clamp attached to a rectangular magnetic object;

FIG. 5 is a top perspective view of a second embodiment of the invention having a hinge;

FIG. 6 is a bottom perspective view of the second embodiment having a hinge;

FIG. 7 is a top perspective view of the second embodiment with the faces of the magnets rotated toward each other; and,

FIG. 8 is a top perspective view of the second embodiment with the faces of the magnets rotated away from each other.

### MODES FOR CARRYING OUT THE INVENTION

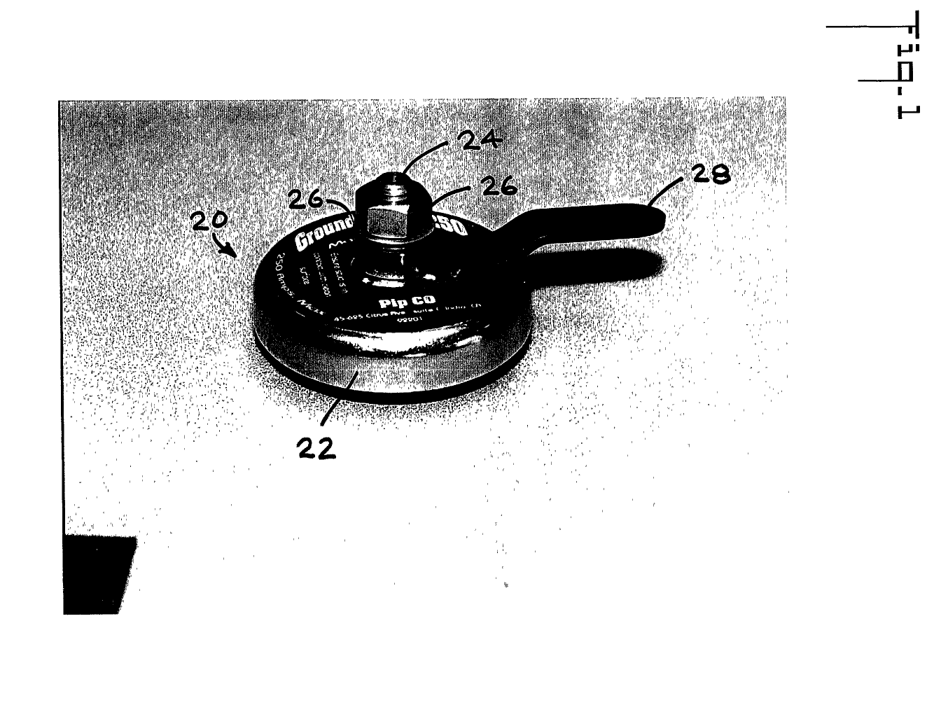

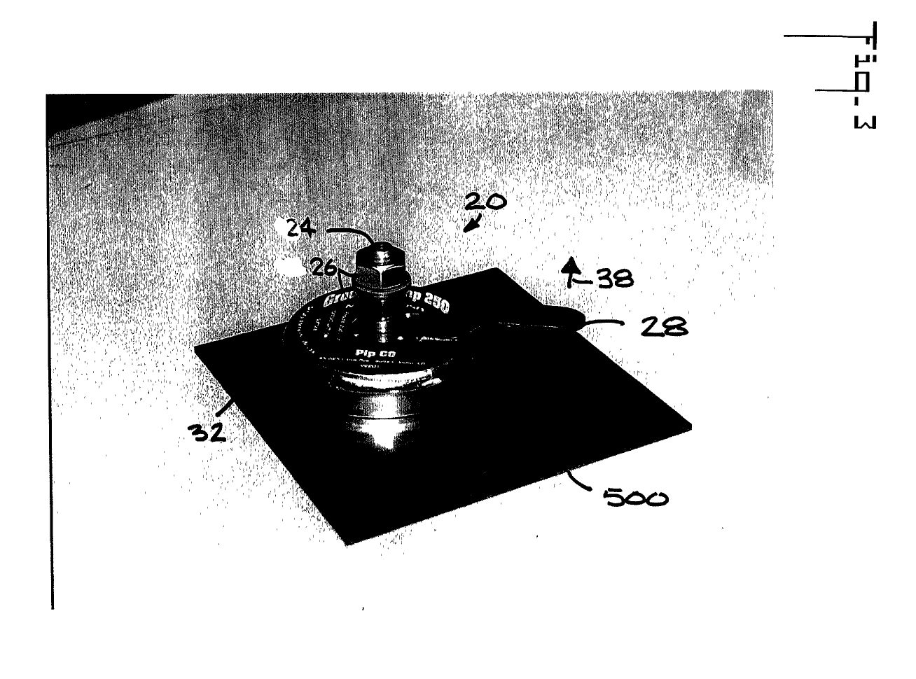

Referring initially to FIG. 1, there is illustrated a side perspective view of a welding clamp in accordance with the present invention, generally designated as 20. Welding clamp 20 includes a magnetic ground clamp 22 having a threaded post 24 and at least one nut 26 (two in the shown preferred embodiment) for connection of a welding cable. Circular magnetic ground clamp 22 is known in the art, and may be obtained from any welding supply firm. A removal tab 28 is connected to magnetic ground clamp 22. Removal tab 28 has a hole 32 (refer also to FIG. 3) to receive threaded post 24. Nut 26 is then used to secure removal tab 28 to magnetic ground clamp 22.

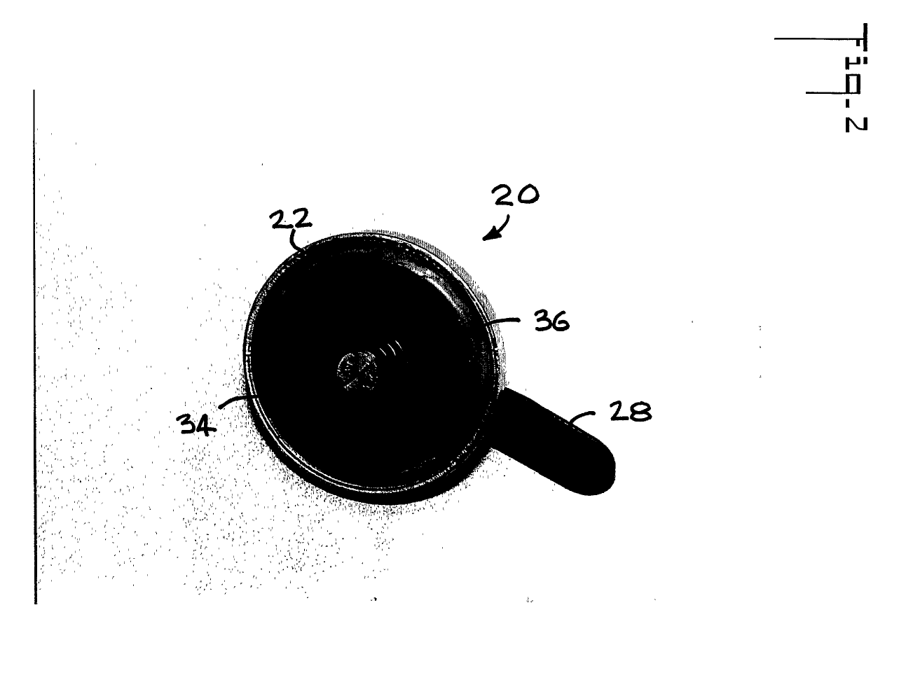

FIG. 2 is a bottom perspective view of welding clamp 20. Magnetic ground clamp 22 has a spring loaded terminal 34, which is disposed in a hole in magnet 36.

FIG. 3 is a side perspective view of welding clamp 20 attached to a flat magnetic object 500. Welding clamp 20 may be removed from object 500 by lifting removal tab 28 in direction 38.

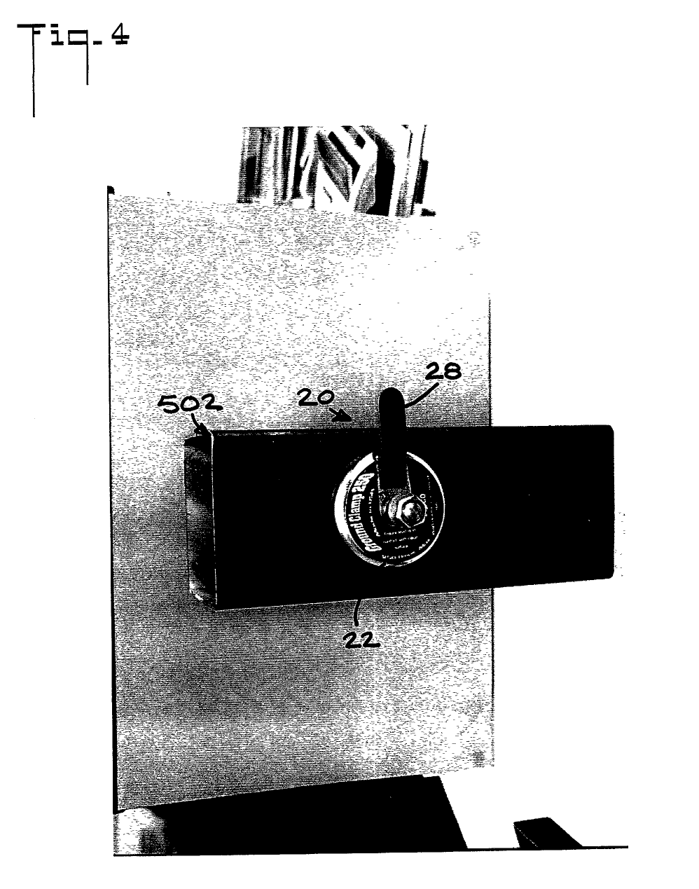

FIG. 4 is a side view of welding clamp 20 attached to rectangular magnetic object 502. Again, removal tab 28 may be used to lift or pry welding clamp 20 from magnetic object 502.

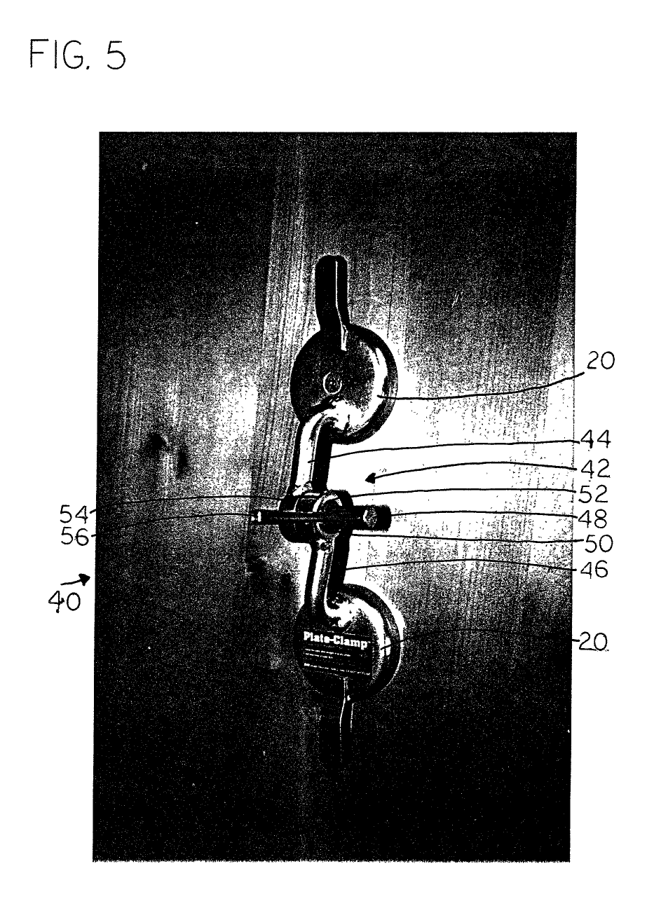

FIG. 5 is a top perspective view of a second embodiment of the welding clamp having a hinge, generally designated 40. Two of the welding clamps 20 shown in FIGS. 1-4 are welded onto a hinge 42 having two arms 44 and 46. A bolt 48 with a shoulder 50 is inserted through a hole in the upper part 52 of the hinge into the lower part 54 of the hinge 42 which has threads matching the bolt. An arm 56 through the bolt 48 provides a lever for rotating the bolt. The arm 56 is loosely fit in a hole in the bolt so that it can be moved from side to side of the bolt as desired to work in various clamping situations. As shown in FIG. 5, the faces of the magnets are in the same plane.

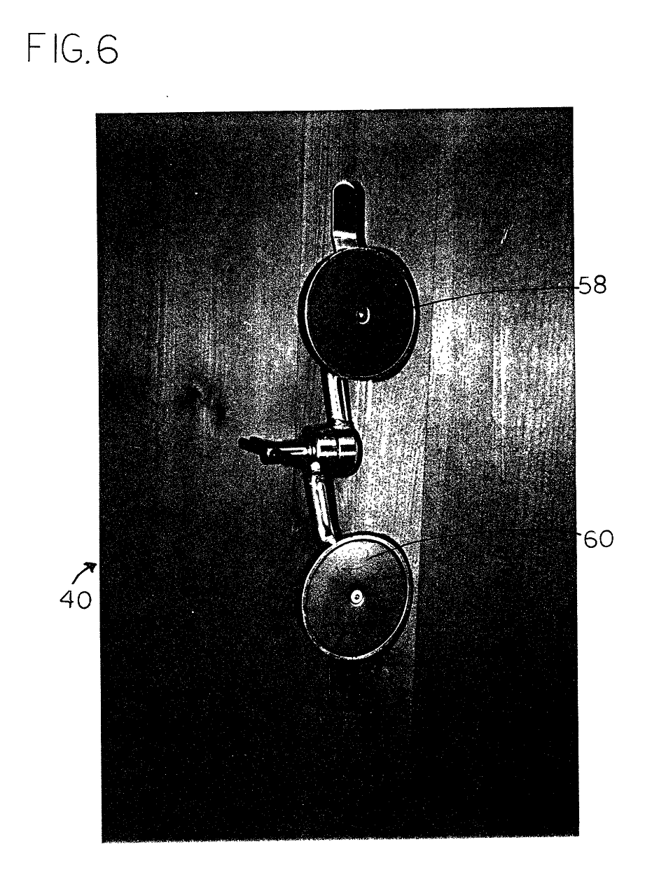

FIG. 6 is a bottom perspective view of the second embodiment of the welding clamp 40 showing the faces 58 and 60 in the same plane.

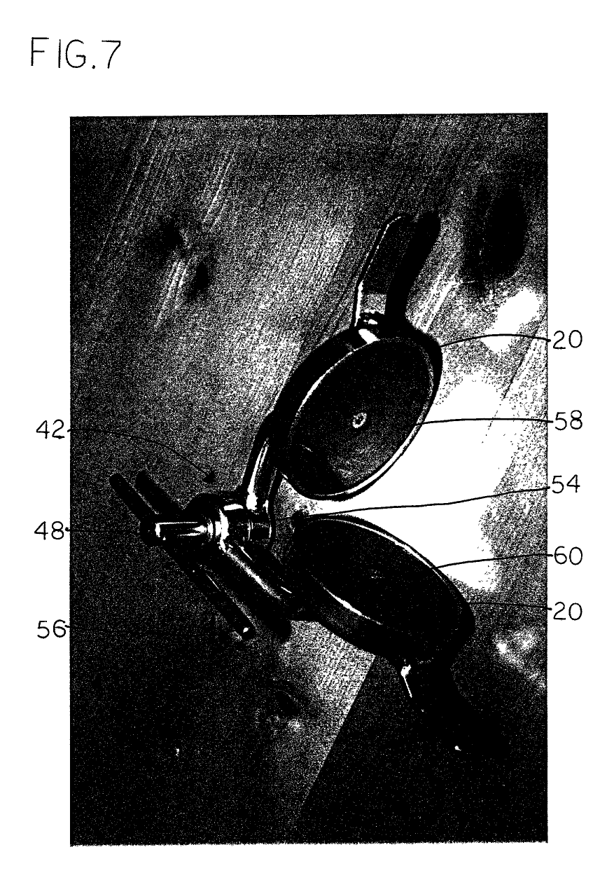

FIG. 7 is a top perspective view of the second embodiment with the faces 58 and 60 magnets rotated toward each other. In order to move from the position shown in FIG. 6 to the position shown in FIG. 7, the bolt 48 is rotated using the arm 56 in the threads of the lower part 54 of the hinge 42 to loosen the hinge. The magnets 20 are then rotated in relation to each other to the position shown in FIG. 7. The bolt 48 is then rotated in the opposite direction to tighten the hinge to secure the overall angular relationship shown in FIG. 7.

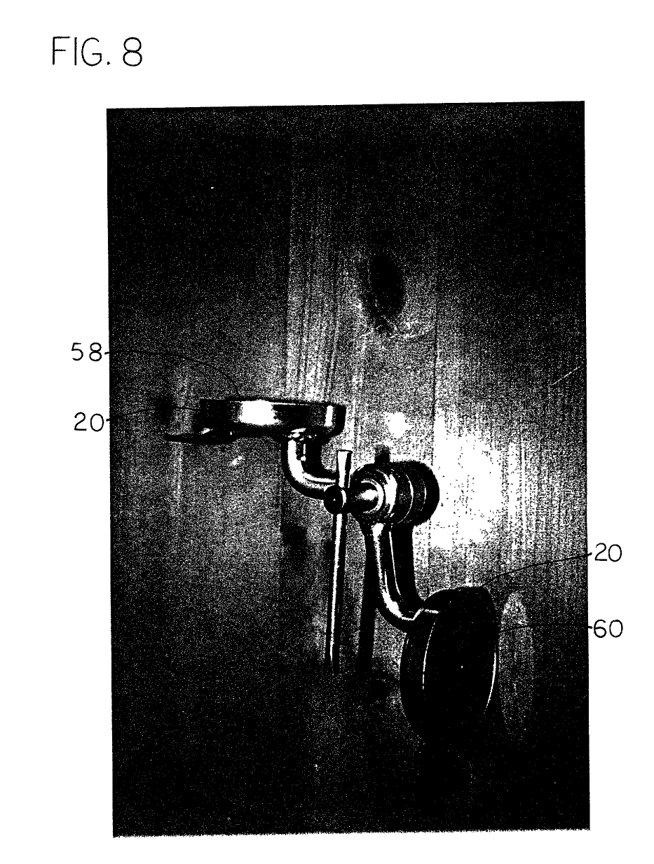

FIG. 8 is a top perspective of the second embodiment with the faces 58 and 60 of the magnets rotated away from each other. The same procedure is followed as described above in conjunction with FIG. 7 except the magnets 20 are rotated away from each other.

Other features and advantages of the present invention will become apparent from the accompanying drawings, which illustrate, by way of example, the principles of the invention. The preferred embodiments of the invention described herein are exemplary and numerous modifications, dimensional variations, and rearrangements can be readily envisioned to achieve an equivalent result, all of which are intended to be embraced within the scope of the appended claims.

I claim:

1. A welding clamp, comprising:
a magnetic ground clamp; and,
a removal tab connected to said ground clamp.

2. A welding clamp according to claim 1, further including:
said magnetic ground clamp being circular.

3. A welding clamp according to claim 1, further including:
said magnetic ground clamp having a threaded post and at least one nut;
said removal tab having a hole to receive said threaded post; and,
said nut used to secure said removal tab to said magnetic ground clamp.

4. A method of removing a welding clamp from a magnetic object, comprising:
providing a magnetic object;
providing said welding clamp having a removal tab, said welding clamp attached to the magnetic object; and,
using said removal tab to remove said welding clamp from the magnetic object.

5. A welding clamp, comprising:
two magnetic ground clamps;
a hinge coupled between said two magnetic ground clamps; and,
a removal tab connected to at least one of said two ground clamps.

6. A welding clamp according to claim 5, further including:
said magnetic ground clamps being circular.

7. A welding clamp according to claim 5, further including:
each of said magnetic ground clamps having a threaded post and at least one nut;
said removal tab having a hole to receive said threaded post; and,
said nut used to secure said removal tab to said magnetic ground clamp.

8. A welding clamp according to claim 5, further including a removal tab connected to each of said two ground clamps.
